(19) United States
(12) Patent Application Publication
(10) Pub. No.: US 2016/0119896 A1
(43) Pub. Date: Apr. 28, 2016

(54) METHODS FOR HANDLING OF USER EQUIPMENT PAGES IN RADIO RESOURCE CONTROL CONNECTED MODE

(71) Applicant: QUALCOMM Incorporated, San Diego, CA (US)

(72) Inventors: Siva Kumar JUJARAY, San Diego, CA (US); Madhusudan KINTHADA VENKATA, San Diego, CA (US); Arun Prasanth BALASUBRAMANIAN, Hyderabad (IN); Daniel AMERGA, San Diego, CA (US); Nitin PANT, San Diego, CA (US); Shyamal RAMACHANDRAN, San Diego, CA (US); Pankaj Subhash VASANDANI, San Diego, CA (US); Arvind Vardarajan SANTHANAM, San Diego, CA (US)

(21) Appl. No.: 14/918,745

(22) Filed: Oct. 21, 2015

(30) Foreign Application Priority Data
Oct. 22, 2014 (IN) 3374/MUM/2014

(51) Int. Cl. H04W 68/02; H04W 76/04; H04W 76/06; H04W 56/00

(52) U.S. Cl. CPC H04W 68/02; H04W 56/001; H04W 76/046; H04W 76/068; H04W 88/06

(57) ABSTRACT

Certain aspects of the present methods for handling user equipment (UE) pages in a Radio Resource Control (RRC) connected mode of the UE. Aspects of the present disclosure may effectively scale a point (in time) until which the UE shall handle pages in the RRC connected mode, and after which the UE detects out-of-sync with the NW, which may allow the UE to performs procedures that may help enhance user experience.

### CROSS-REFERENCE TO RELATED APPLICATIONS UNDER 35 U.S.C. §119

This application claims priority to Indian Provisional Patent Application No. 3374/MUM/2014, filed Oct. 22, 2014, entitled “METHODS FOR HANDLING OF USER EQUIPMENT PAGES IN RADIO RESOURCE CONTROL CONNECTED MODE,” which is hereby expressly incorporated by reference herein.

### FIELD

Certain aspects of the present disclosure generally relate to wireless communications and, more particularly, to methods for handling user equipment (UE) pages in the Radio Resource Control (RRC) connected mode of the UE.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple-out (MIMO) system.

A MIMO system employs multiple (NT) transmit antennas and multiple (NR) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system may support time division duplex (TDD) and/or frequency division duplex (FDD) systems. In a TDD system, the forward and reverse link transmissions are on the same frequency region so that the reciprocity principle allows the estimation of the forward link channel from the reverse link channel. This enables the base station to extract transmit beamforming gain on the forward link when multiple antennas are available at the base station. In an FDD system, forward and reverse link transmissions are on different frequency regions.

### SUMMARY

Certain aspects of the present disclosure provide a method for wireless communications by a user equipment (UE). The method generally includes processing one or more page messages from a network while the UE is in a transient state between an idle mode and a connected mode, processing one or more other page messages from the network until a specific moment in the connected mode, determining the UE is out-of-sync with the network if a page message is received while the UE is in the connected mode, and taking action to transition from the connected mode to the idle mode after detecting the UE is out-of-sync with the network.

Certain aspects of the present disclosure provide a method for wireless communications by a user equipment (UE). The method generally includes receiving, from a network, a page message when the UE is in a connected mode, determining, upon receiving the page message, that the UE is out-of-sync with the network, and taking action to transition from the connected mode to an idle mode, based on the determination.

Certain aspects of the present disclosure also provide various apparatus and program products (e.g., comprising computer-readable medium) for performing operations of the methods described above.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a multiple access wireless communication system, in accordance with certain aspects of the present disclosure.

FIG. 2 illustrates a block diagram of a communication system, in accordance with certain aspects of the present disclosure.

FIG. 3 illustrates an example of different operating modes when a user equipment (UE) may handle pages, in accordance with certain aspects of the present disclosure.

FIG. 4 illustrates example operations for handling pages in a connected mode of a UE, in accordance with certain aspects of the present disclosure.

FIG. 4A illustrates example means capable of performing the operations shown in FIG. 4.

FIG. 5 illustrates example operations for handling pages in a connected mode of a UE, in accordance with certain aspects of the present disclosure.

FIG. 5A illustrates example means capable of performing the operations shown in FIG. 5.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, an eNode B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA 2000, etc. UTRA includes Wideband-CDMA (W-CDMA). CDMA2000 covers IS-2000, IS-95 and IS-856 standards. A TDMA network may implement a radio technology such as Global System for Mobile Communications (GSM).

An OFDMA network may implement a radio technology such as Evolved UTRA (E-UTRA), The Institute of Electrical and Electronics Engineers (IEEE) 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a recent release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various applications involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ratio (PAPR) because of its inherent single carrier structure. SC-FDMA may be used in the uplink communications where lower PAPR greatly benefits the mobile terminal in terms of transmit power efficiency. SC-FDMA is currently a working assumption for uplink multiple access scheme in 3GPP Long Term Evolution (LTE), or Evolved UTRA.

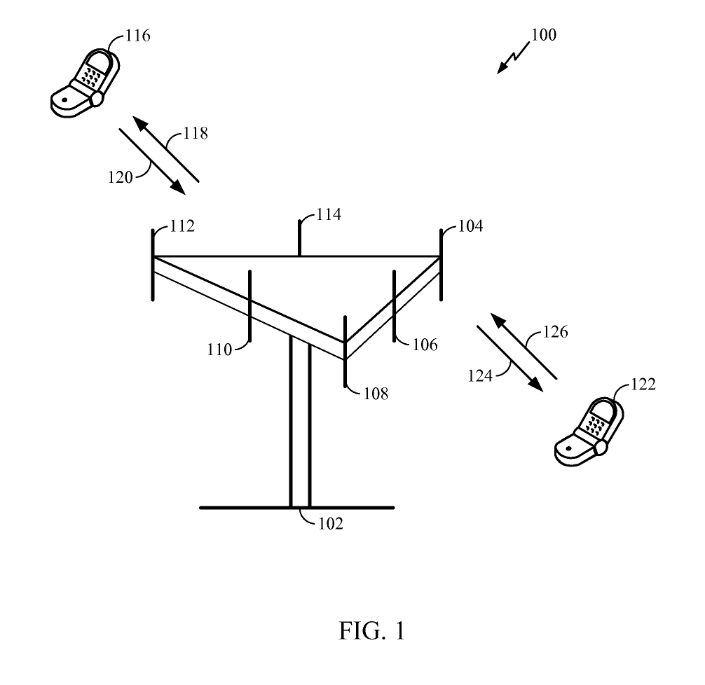

Referring to FIG. 1, a multiple access wireless communication system 100 according to one aspect is illustrated, in which aspects of the present disclosure may be practiced. An access point (AP) 102 includes multiple antenna groups, one including 104 and 106, another including 108 and 110, and an additional including 112 and 114. In FIG. 1, only two antennas are shown for each antenna group, however, more or fewer antennas may be utilized for each antenna group. The access terminal 116 is in communication with antennas 112 and 114, where antennas 112 and 114 transmit information to access terminal 116 over forward link 118 and receive information from access terminal 116 over reverse link 120. The access terminal 122 is in communication with antennas 104 and 106, where antennas 104 and 106 transmit information to access terminal 122 over forward link 124 and receive information from access terminal 122 over reverse link 126. In a Frequency Division Duplex (FDD) system, communication links 118, 120, 124 and 126 may use a different frequency for communication. For example, forward link 118 may use a different frequency than that used by reverse link 120.

Each group of antennas and/or the area in which they are designed to communicate is often referred to as a sector of the access point. In an aspect, antenna groups each are designed to communicate to access terminals in a sector of the areas covered by access point 102.

In communication over forward links 118 and 124, the transmitting antennas of access point 102 utilize beamforming in order to improve the signal-to-noise ratio of forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a Node B, an evolved Node B (eNB), or some other terminology. An access terminal may also be called a mobile station, user equipment (UE), a wireless communication device, terminal, or some other terminology. For certain aspects, either the AP 102 or the access terminals 116, 122 may utilize an interference cancellation technique as described herein to improve performance of the system.

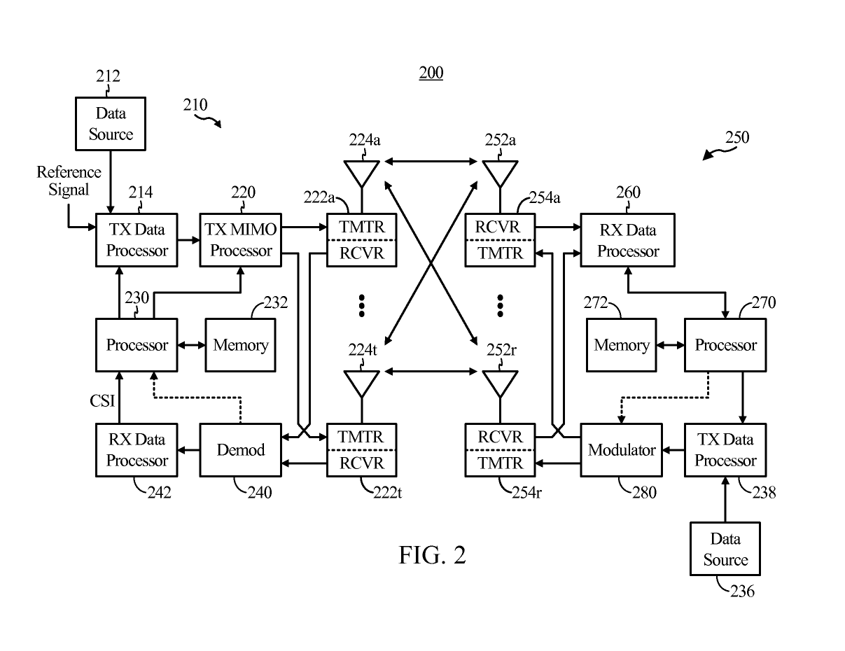

Referring to FIG. 2, a block diagram of an aspect of a transmitter system 210 (also known as an AP) and a receiver system 250 (also known as an AT) in a MIMO system 200 is illustrated, in which aspects of the present disclosure may be practiced. At the transmitter system 210, traffic data for a number of data streams is provided from a data source 212 to a transmit (TX) data processor 214. An aspect of the present disclosure is also applicable to a wire-line (wired) equivalent system of FIG. 2

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., Binary Phase Shift Keying (BPSK), Quadrature Phase Shift Keying (QPSK), M-PSK in which M may be a power of two, or M-QAM (Quadrature Amplitude Modulation)) selected for that data stream to provide modulation symbols. The data rate, coding and modulation for each data stream may be determined by instructions performed by processor 230 that may be coupled with a memory 232.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves and decodes each detected symbol stream to recover the traffic data for the data stream. The processing by RX data processor 260 is complementary to that performed by TX MIMO processor 220 and TX data processor 214 at transmitter system 210. As described in further detail below, the RX data processor 260 may utilize interference cancellation to cancel the interference on the received signal.

Processor 270, coupled to a memory 272, formulates a reverse link message. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240 and processed by a RX data processor 242 to extract the reserve link message transmitted by the receiver system 250.

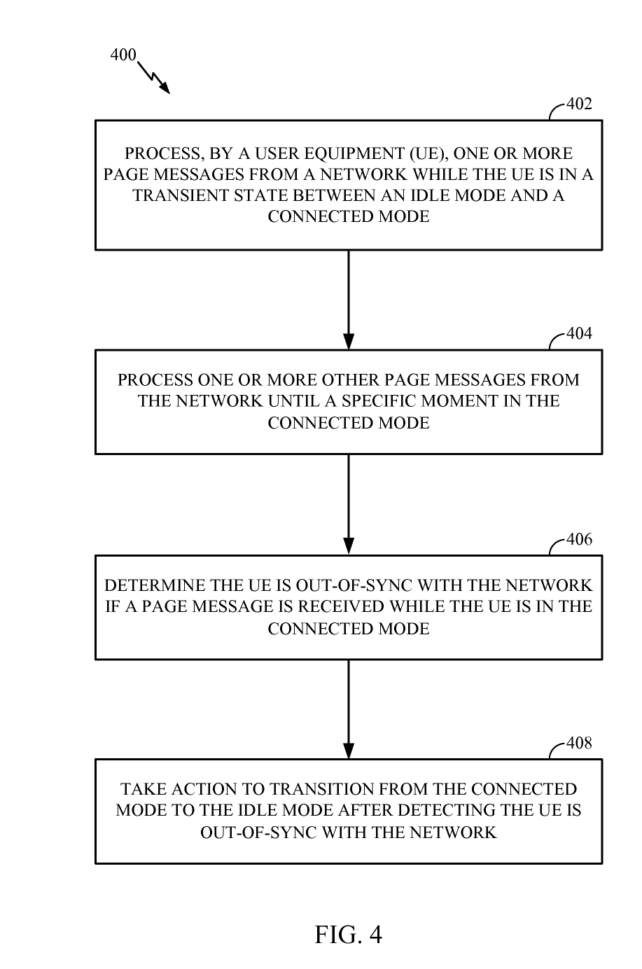

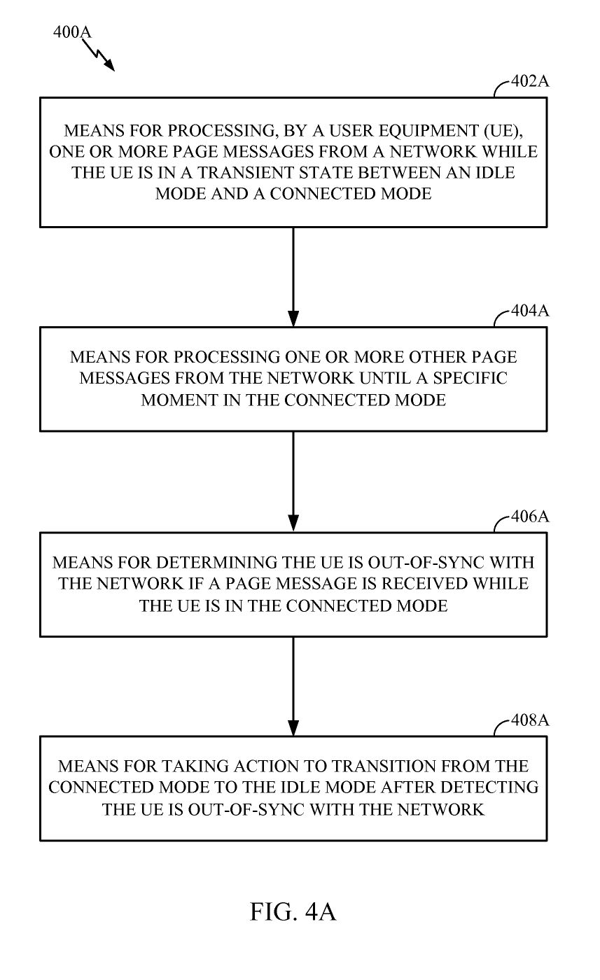

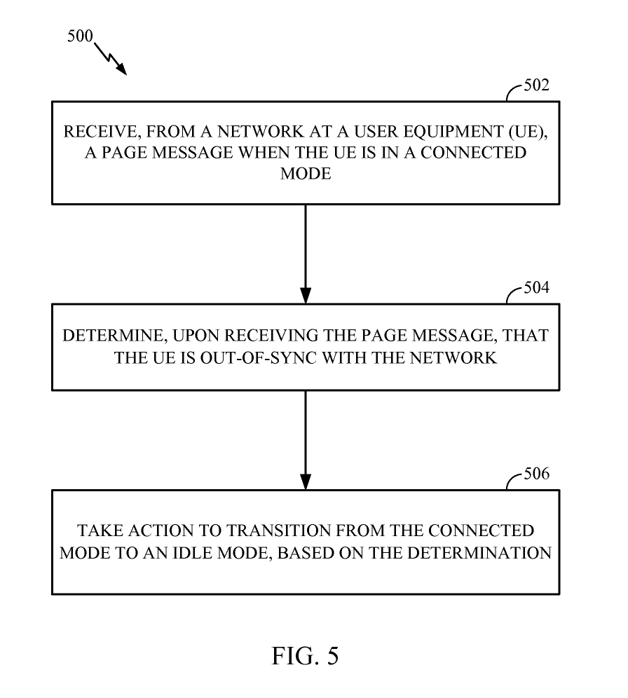

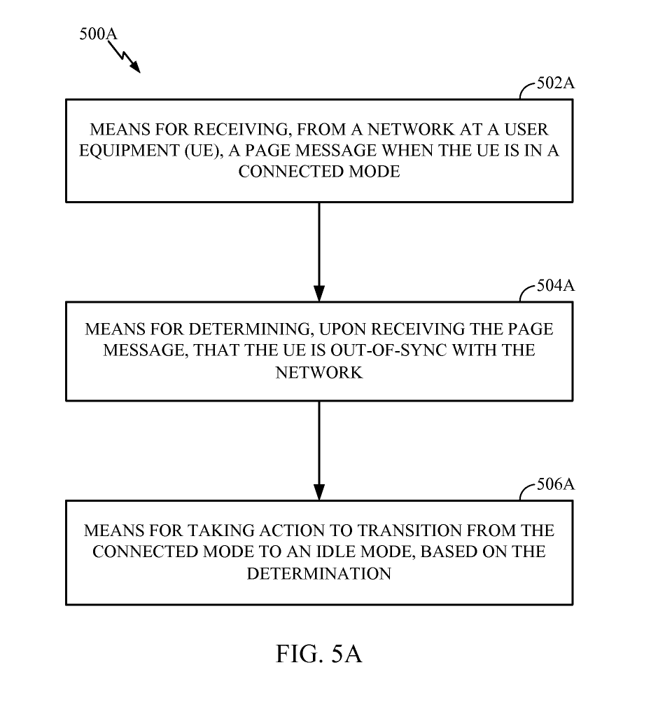

According to certain aspect of the present disclosure, the controller/processor 270, the transceivers 254 and/or other processors and modules at the receiver system 250 may perform or direct operations 400, 500 in FIGS. 4-5 and/or other processes for the techniques described herein. However, any component and/or processor in FIG. 2 may perform the processes for the techniques described herein.

Ideally, a network (NW) (or the transmitter system 210) should not page a UE (or the receiver system 250) once it has entered Radio Resource Control (RRC) Connected state (mode). However, for cases where the UE has missed the connection release message from the NW and stays in the connected mode, or in a certain NW implementation where the NW periodically pages the UE a fixed number of times even after the UE has entered the connected mode, or when the NW gets to know that the UE has entered the connected mode later than the UE has actually entered the connected mode, the current technology may allow the UE to ignore the pages. However, this approach does not provide a good user experience.

Aspects of the present disclosure provide a method to scale a point (in time) until which the UE shall handle pages in the RRC connected mode, and after which the UE detects out-of-sync with the NW and performs the necessary procedure for better user experience.

### Page Handling in RRC Connected Mode and Detection of Out-of-Sync with Network

UEs in Idle mode typically monitor a paging channel for paging messages (“pages”) to detect incoming calls, system information change, and the like. For a mobile terminated call, a paging message is sent via SGs interface to a Mobility Management Entity (MME) identified based on location update information. After detecting a page, the UE may transition to a radio resource control (RRC) connected state.

Typically, the network would not page the UE once it has entered the RRC Connected state. While a UE monitors for pages while in Idle mode, there are various scenarios where a UE may receive a page when it is not expecting to be paged. For example, a UE may receive a page from the network while in a transient state between Idle and Connected Modes, such as when the UE has initiated (or is initiating) a Connection Establishment procedure but is waiting for a Connection Setup Message.

A UE may also receive a packet switched (PS) or circuit switched (CS) page while the UE is in Connected Mode. Detection of such page messages may indicate, to the UE, that the UE is out-of-sync with the network (e.g., the network may be wrong about the RRC idle/connected state of the UE). This out-of-sync state may occur, for example, if the UE has missed a Connection Release Message from the network and stays in Connected mode. Further, in certain network implementation, the UE may be paged periodically a fixed number of times even after the UE has entered the Connected state. In addition, for some reasons, the network may learn the UE has entered the Connected state later than when it actually entered the Connected state.

While the UE could simply ignore such pages, this may not lead to an ideal user experience, as the UE and network as performance may suffer as the UE and network stay out-of-sync.

Aspects of the present disclosure provide techniques for handling such pages. In some cases, the techniques presented herein may effectively scale the point until which a UE may handle pages while in RRC Connected and the point after which the UE considers the page indicative of an out-of-sync with the network and may take action to improve user experience.

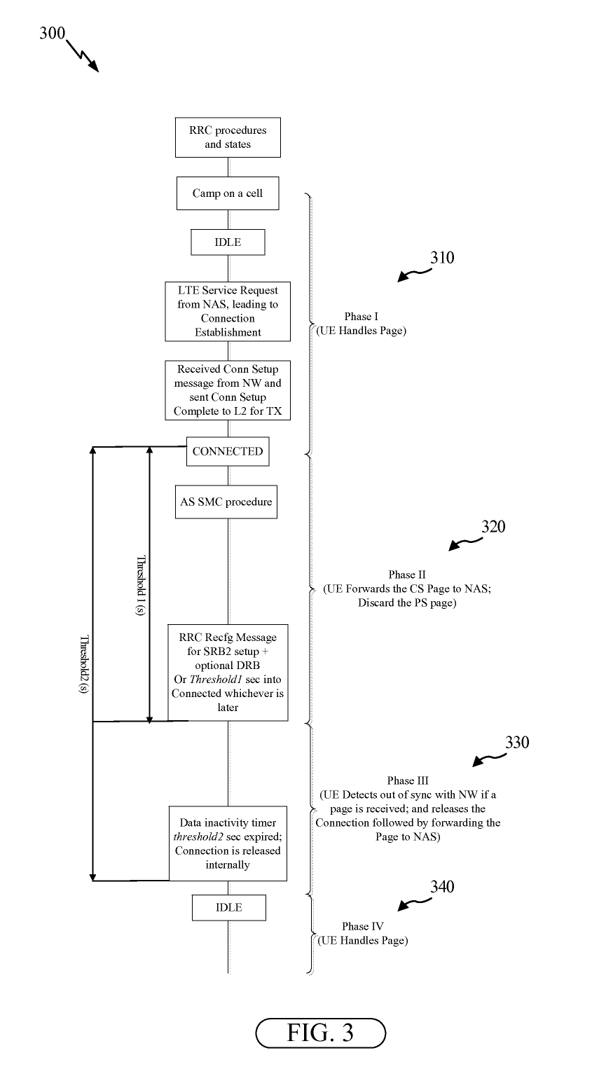

Certain techniques for handling pages in accordance with aspects of the present disclosure may be described with reference to FIG. 3 that shows how different different operating phases of the UE may defined and page handling may depend on which phase the UE is currently operating in.

As illustrated, a first phase 310 generally refers to the time from Idle state up to the Connected state. As illustrated, this phase may include the LTE Service request leading to Connection Establishment, with the UE receiving the Connection Setup message and sending a Connection Complete message for transmission to the network. In this phase, the UE may handle pages (normally).

As illustrated, according to certain aspects of the present disclosure, during a second phase 320 defined by a certain point into the Connected state, the UE may decode CS pages and forward these decoded CS pages to a non-access stratum (NAS), while the UE may ignore the PS page(s). The certain point may be based on an event, such as Signaling Radio bearer (e.g., SRB2) coming up or based on time, for example, after Threshold) seconds into the connected mode, or both (e.g., whichever is later). In an aspect of the present disclosure, the NAS may handle the CS pages and may piggyback the extended service request (ESR) procedure on top of the on-going connection, if required, or the NAS may ignore the CS pages if the ESR procedure is already on-going.

According to certain aspects of the present disclosure, during a third phase 330 (e.g., post SRB2 setup or Threshold) sec into the connected mode whichever is later), if a page is received at the UE, out-of-sync with the network may be detected (declared) and the UE may release the connection and return to Idle state (Phase IV 340). In addition, the UE may forward the received page to the NAS that caused the connection release. Also, if a data-inactivity-time duration associated with the UE has passed Threshold2, the UE may implicitly release the connection. As illustrated, Threshold2 may be different than (e.g., greater than) Threshold1.

In an aspect of the present disclosure, the thresholds described above may each be defined as some multiple of Discontinuous Reception (DRX) cycles. For example, Threshold) may comprise x Discontinuous Reception (DRX) cycles, and Threshold2 may comprise y DRX cycles. DRX cycle ranges are {320 ms, 640 ms, 1280 ms, 2560 ms}. In an aspect of the present disclosure, both Threshold) and Threshold2 may comprise a static period of up to N milliseconds.

FIG. 4 illustrates example operations 400 performed by a UE for handling pages, in accordance with certain aspects of the present disclosure. The operations 400 may generally be performed, for example, by a UE that handles pages in accordance to the operating phases shown in FIG. 3.

The operations 400 begin, at 402, by processing one or more page messages from a network while the UE is in a transient state between an idle mode and a connected mode. At 404, the UE may process one or more other page messages from the network until a specific moment in the connected mode. At the 406, the UE may determine that it is out-of-sync with the network if a page message is received while the UE is in the connected mode. At 408, the UE may take action to transition from the connected mode to the idle mode after detecting the UE is out-of-sync with the network.

According to aspects of the present disclosure, processing one or more other page messages comprises processing the one or more other page messages until the specific moment before the UE reaches a steady state in the connected mode. In an aspect of the present disclosure, the UE may move from the transient state to the connected mode and process the one or more other page messages until a specific moment into the Connected mode. For example, as described above with reference to FIG. 3, the specific moment may be defined as the latter of until SRB2 associated with the UE is up or a first time period into the connected mode elapsed (e.g., Threshold1 s into Connected mode). As described above, the first time period may comprise a defined number of Discontinuous Reception (DRX) cycles or a static period of up to N milliseconds

According to aspects of the present disclosure, the UE may implicitly release the connection with the network, if a data-inactivity time duration associated with the UE passed a second time period (e.g., Threshold2 s into Connected mode) different than the first time period. As described above, the second time period may comprise a defined number of Discontinuous Reception (DRX) cycles or a static period of up to N milliseconds. In an aspect, the UE may take action to transition back to the idle mode after releasing the connection with the network.

According to aspects of the present disclosure, processing the one or more page messages (e.g., in Phase II of FIG. 3) may involve at least one of: decoding one or more Circuit Switched (CS) pages, forwarding the one or more CS pages to an upper layer of the UE; decoding one or more Packet Switched (PS) pages, or forwarding the one or more PS pages to the upper layer of the UE.

According to aspects of the present disclosure, processing the one or more other page messages (e.g., in Phase IV of FIG. 3) may comprise: decoding one or more Circuit Switched (CS) pages; forwarding the one or more CS pages to an upper layer of the UE; and ignoring one or more Packet Switched (PS) pages. In an aspect, the UE may initiate, based on the one or more CS pages, an extended service request (ESR) procedure. In another aspect, the UE may ignore the one or more CS pages if an extended service request (ESR) procedure has already been initiated.

### Long Term Evolution (LTE) Mobile Terminated (MT) Page Honoring in RRC Connected Mode

As described above, there are various scenarios when a UE may become out-of-sync with the network which may cause performance problems. For example, Mobile Terminated (MT) Circuit Switched Fallback/Voice-over Long Term Evolution (CSFB/VoLTE) call drop (e.g., CS paging) may occur when a UE thinks it is in a connected mode but a network has actually released the connection. This may occur, for example if, the UE was not able to decode the RRC connection release message because of temporary high interference in downlink (e.g., deep fading, hand grip at antenna). When the UE is in a passive connected mode (e.g., no data transfer ongoing), even if an eNB sends the RRC connection release with a lower modulation-coding scheme (MCS) when the UE is in a high interference region it may be possible that the UE is unable to decode it even with retransmission.

In such scenarios, there is a temporary out-of-sync between the UE and the eNB (e.g., network) with respect to the RRC state. If there is an MT page during this time, the network may page the UE assuming it is in a RRC idle mode. However, the UE may discard the page as it assumes it is in the connected mode. Aspects of the present disclosure, however, may allow a UE to handle such pages.

For example, according to certain aspects of the present disclosure, on receiving the page (e.g., with M-Temporary Mobile Subscriber Identity (M-TMSI) or International Mobile Subscriber Identity (IMSI)) in the connected mode, the UE may review its decoding/transmit history (e.g., downlink and uplink) and look for out-of-sync state between the UE and the network. In an aspect of the present disclosure, the UE may check the following conditions as indicative of an out-of-sync state: if there is 100% (or a defined) block error rate (BLER) in last downlink Cell Radio Network Temporary Identifier (DL C-RNTI) transmissions (e.g., x number of transmissions) even when the network transmits a packet with multiple Redundancy Versions (RV); the UE does not get a DL grant from the network after the BLER occurrence; and there was no uplink (UL) data transmitted by the UE successfully after the BLER occurrence. If one or more of the above conditions are met, the UE may locally release the RRC connection, honor the page and move back to the connected state through RRC connection establishment procedure with cause indicated as MT-access.

In another aspect of the present disclosure, other conditions for the out-of-sync state may be checked when the UE is a dual-SIM (Subscriber Identification Module), dual standby device (or, alternatively, triple-SIM triple standby device). These other conditions, for example, may include: the UE has not received/transmitted data to the network after a last tune-away from LTE Radio Access Technology (RAT) to another RAT; and a page arrived at the UE with M-TMSI or IMSI corresponding to LTE RAT subscription. If these conditions are met, the UE should locally release the RRC connection, honor the page and move back to the connected state through RRC connection establishment procedure with cause indicated as MT-access.

In an aspect of the present disclosure, during the tune-away from the LTE RAT to the other RAT, the LTE RAT may leave Radio Frequency (RF) chains to the other RAT to perform its activities. On completion of such activities by the other RAT, the RF chains may be given by to the LTE RAT. In another aspect, the tune-away may represent a temporary loss of RF chains for performing other RAT activities. In yet another aspect, the tune-away may comprise tune back from the other RAT to the LTE RAT.

FIG. 5 illustrates example operations 500 performed by a UE for handling pages, in accordance with certain aspects of the present disclosure, to handle a page received while in a connected state. The operations 500 begin, at 502, by receiving, from a network, a page message when the UE is in a connected mode. At 504, the UE may determine, upon receiving the page message, that the UE is out-of-sync with the network. At 506, the UE may take action to transition from (moving to) the connected mode to an idle mode, based on the determination.

According to aspects of the present disclosure, taking action may comprise: locally releasing a radio resource control (RRC) connection with the network; and switching, after locally releasing the RRC connection, from the connected mode to the idle mode based on the page message. In an aspect, the page message may be received with an M-Temporary Mobile Subscriber Identity (M-TMSI) or an International Mobile Subscriber Identity (IMSI). In an aspect, the UE may take action to transition back to the connected mode from the idle mode.

As discussed above, determining that the UE is out-of-sync with the network may involve one or more of: determining that a block error rate (BLER) of a defined number of downlink (DL) transmissions is greater than (meets or exceeds) a threshold; determining that the UE does not get a DL grant from the network after the BLER occurrence; and determining that no uplink (UL) data is transmitted successfully by the UE after the BLER occurrence. In an aspect, the DL transmissions may comprise DL Cell Radio Network Temporary Identifier (DL C-RNTI) transmissions

As discussed above, determining that the UE is out-of-sync with the network may involve one or more of: determining that the UE has not communicated data (e.g., both DL and UL data) with the network after a last tune-away from LTE Radio Access Technology (RAT) to another RAT; and determining that the page message arrived at the UE with an M-Temporary Mobile Subscriber Identity (M-TMSI) or an International Mobile Subscriber Identity (IMSI) corresponding to Long Term Evolution (LTE) RAT subscription. In an aspect, the UE may be configured as a dual subscriber identification module (dual SIM) dual standby device or a triple subscriber identification module (triple SIM) triple standby device.

The various operations of methods described above may be performed by any suitable means capable of performing the corresponding functions. The means may include various hardware and/or software component(s) and/or module(s), including, but not limited to a circuit, an application specific integrated circuit (ASIC), or processor, such as the processor 270 of the receiver system 250 illustrated in FIG. 2. Generally, where there are operations illustrated in figures, those operations may have corresponding counterpart means-plus-function components with similar numbering. For example, operations 400, 500 illustrated in FIGS. 4-5 correspond to means 400A, 500A illustrated in FIGS. 4A-5A.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for wireless communications by a user equipment (UE), comprising:
processing one or more page messages from a network while the UE is in a transient state between an idle mode and a connected mode;
processing one or more other page messages from the network until a specific moment in the connected mode;
determining the UE is out-of-sync with the network if a page message is received, after the specific moment, while the UE is in the connected mode; and
taking action to transition from the connected mode to the idle mode after detecting the UE is out-of-sync with the network.

2. The method of claim 1, wherein:
the specific moment corresponds to a moment the UE reaches a steady state in the connected mode.

3. The method of claim 1, further comprising:
moving from the transient state to the connected mode; and
wherein the specific moment is defined as a later of a Signaling Radio Bearer 2 (SRB2) associated with the UE coming up or a first time period into the connected mode having elapsed.

4. The method of claim 3, wherein the first time period comprises a defined number of Discontinuous Reception (DRX) cycles or a static period of up to N milliseconds.

5. The method of claim 3, further comprising:
implicitly releasing a connection with the network, if a data-inactivity time duration associated meets or exceeds a second time period different than the first time period.

6. The method of claim 5, wherein the second time period comprises a defined number of Discontinuous Reception (DRX) cycles or a static period of up to N milliseconds.

7. The method of claim 1, further comprising:
taking action to transition back to the idle mode after releasing a connection with the network.

8. The method of claim 1, wherein processing the one or more page messages comprises:
decoding one or more Circuit Switched (CS) pages; and
forwarding the one or more CS pages to an upper layer of the UE.

9. The method of claim 1, wherein processing the one or more page messages comprises:
decoding one or more Packet Switched (PS) pages; and
forwarding the one or more PS pages to the upper layer of the UE.

10. The method of claim 1, wherein processing the one or more other page messages comprises:
ignoring one or more Packet Switched (PS) pages.

11. The method of claim 8, further comprising:
initiating, based on the one or more CS pages, an extended service request (ESR) procedure.

12. A method for wireless communications by a user equipment (UE), comprising:
receiving, from a network, a page message when the UE is in a connected mode;
determining, upon receiving the page message, that the UE is out-of-sync with the network; and
taking action to transition from the connected mode to an idle mode, based on the determination.

13. The method of claim 12, wherein taking action comprises:
locally releasing a radio resource control (RRC) connection with the network; and
switching, after locally releasing the RRC connection, from the connected mode to the idle mode based on the page message.

14. The method of claim 12, wherein:
the page message is received with an M-Temporary Mobile Subscriber Identity (M-TMSI) or an International Mobile Subscriber Identity (IMSI).

15. The method of claim 12, further comprising:
taking action to transition back to the connected mode from the idle mode.

16. The method of claim 12, wherein the determining comprises at least one of:
determining that a block error rate (BLER) of a defined number of downlink (DL) transmissions is greater than a threshold;
determining that the UE does not get a DL grant from the network after the BLER occurrence; or
determining that no uplink (UL) data is transmitted successfully by the UE after the BLER occurrence.

17. The method of claim 16, wherein the DL transmissions comprise DL Cell Radio Network Temporary Identifier (DL C-RNTI) transmissions.

18. The method of claim 12, wherein the determining comprises:
determining that the UE has not communicated data with the network after a last tune-away from Long Term Evolution (LTE) Radio Access Technology (RAT) to another RAT; and
determining that the page message arrived at the UE with an M-Temporary Mobile Subscriber Identity (M-TMSI) or an International Mobile Subscriber Identity (IMSI) corresponding to LTE RAT subscription.

19. The method of claim 18, wherein the UE is configured as a dual subscriber identification module (dual SIM) dual standby device or a triple subscriber identification module (triple SIM) triple standby device.

20. An apparatus for wireless communications by a user equipment (UE), comprising:
means for processing one or more page messages from a network while the UE is in a transient state between an idle mode and a connected mode;
means for processing one or more other page messages from the network until a specific moment in the connected mode;
means for determining the UE is out-of-sync with the network if a page message is received, after the specific moment, while the UE is in the connected mode; and
means for taking action to transition from the connected mode to the idle mode after detecting the UE is out-of-sync with the network.

21. The apparatus of claim 20, wherein:
the specific moment corresponds to a moment the UE reaches a steady state in the connected mode.

22. The apparatus of claim 20, further comprising:
means for moving from the transient state to the connected mode; and
wherein the specific moment is defined as a later of a Signaling Radio Bearer 2 (SRB2) associated with the UE coming up or a first time period into the connected mode having elapsed.

23. The apparatus of claim 22, wherein the first time period comprises a defined number of Discontinuous Reception (DRX) cycles or a static period of up to N milliseconds.

24. The apparatus of claim 22, further comprising:
means for implicitly releasing a connection with the network, if a data-inactivity time duration associated meets or exceeds a second time period different than the first time period.

25. The apparatus of claim 24, wherein the second time period comprises a defined number of Discontinuous Reception (DRX) cycles or a static period of up to N milliseconds.

26. The apparatus of claim 20, further comprising:
means for taking action to transition back to the idle mode after releasing a connection with the network.

27. An apparatus for wireless communications by a user equipment (UE), comprising:
means for receiving, from a network, a page message when the UE is in a connected mode;
means for determining, upon receiving the page message, that the UE is out-of-sync with the network; and
means for taking action to transition from the connected mode to an idle mode, based on the determination.

28. The apparatus of claim 27, wherein means for taking action comprises:
means for locally releasing a radio resource control (RRC) connection with the network; and
means for switching, after locally releasing the RRC connection, from the connected mode to the idle mode based on the page message.

29. The apparatus of claim 27, further comprising:
means for taking action to transition back to the connected mode from the idle mode.

30. The apparatus of claim 27, wherein the means for determining comprises at least one of:
means for determining that a block error rate (BLER) of a defined number of downlink (DL) transmissions is greater than a threshold;
means for determining that the UE does not get a DL grant from the network after the BLER occurrence; or
means for determining that no uplink (UL) data is transmitted successfully by the UE after the BLER occurrence.
